(19) United States
(12) Patent Application Publication
(10) Pub. No.: US 2008/0260140 A1
(43) Pub. Date: Oct. 23, 2008

(54) Method and System for Scanning and Detecting Metallic Cross-Connects

(75) Inventors: Sture Roos, Mongagua (BR); Johan Oberg, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: NORDIA INNOVATION AB, Stockholm (SE)

(21) Appl. No.: 11/569,161

(22) PCT Filed: May 13, 2005
(86) PCT No.: PCT/IB05/51577

§ 371 Date: Jun. 13, 2008

(30) Foreign Application Priority Data
May 17, 2004 (SE) 0401282-9

(51) Int. Cl. H04M 5/00

(52) U.S. Cl. 379/327

(57) ABSTRACT

A method and system is disclosed for automatically scanning for and detecting existing jumper wires or metallic cross-connects within a central office main distribution frame (MDF), street cabinet, and drop point sites. In an embodiment of the invention, the method includes connecting a plurality of modular sender and receiver units to the MDF connector blocks. Scanning signals are sent between the lines on the subscriber side and the exchange side that are received by the receivers to accurately determine which subscriber lines are cross-connected to which lines on the exchange side. In a second embodiment, the scanning system is operable in cooperation with an automated cross-connect system installed within the MDF or drop point site. The automated cross-connect system comprises modular switch matrix arrangements that enable cross-connects to be established or removed remotely from the central office. The scanning procedure establishes an accurate line connection database that enables non-intrusive installation of the automated cross-connect system by preserving previous cross-connects. Furthermore, the combined operation with the automated cross-connect system enables cable line repairs to be completed with short order by allowing repair crews to connect the broken lines without regard to order such that the original connection sequences that can be restored by automatically modifying the cross-connects in the central office or in the drop point site.

### FIELD OF THE INVENTION

The present invention relates generally to telecommunication networks, and more particularly, to a method and system for scanning to detect jumper wires or metallic cross-connects for non-intrusive equipment installation and cable repair.

### BACKGROUND OF THE INVENTION

A telecommunication central office houses switching equipment or telephone exchange that is the point to which subscriber home and business lines 120 are connected to the network on what is often called a local loop. Many of these connections to residential subscribers are typically made using a pair of copper wires, also referred to as a twisted pair, that collectively form a large copper network operated by the telecom provider. Within the CO the line connections between the exchange side and the subscriber side are terminated at a main distribution frame (MDF), which is usually the point where cross-connections between the subscriber lines and the exchange lines are made. In addition, similar cross-connections may be located in sites closer to the serviced areas such as a local residential area, that are known as drop points and cross-connect cabinets.

Virtually every aspect of the telecommunication network is automated with the notable exception of the copper network. Management of the copper infrastructure is a highly labour intensive process that results in one of the most significant costs faced by telecommunication providers today. By way of example, when a new subscriber requests a service such as a new phone line, technicians are dispatched to a CO to manually add jumper wires to the main distribution frame to activate the line. The similar level of labor is required when a subscriber service needs to be removed or modified. This manual process is naturally prone to errors since the technician can inadvertently make incorrect cross-connects that can delay activation of new services, or cause a temporary loss of existing services. Over time as these wires can accumulate to become such a mishmash to the point where a complete rewiring may be required. When left unchecked, services may be impacted resulting in increased customer dissatisfaction, which would require increased operational expenditures in labor costs to correct the problems. Another problem is that the tremendous growth in installations of new services such as xDSL are relatively labor intensive. The new installations and routine service modifications require numerous jumper wires or are added and removed within the MDF by service technicians, which are not always documented properly. The installations of phone or xDSL service for a subscriber typically involves a relatively high level of manual labor that involve the addition of several jumper wires.

FIG. 1 illustrated the steps required in a typical conventional subscriber installation for telephone service and xDSL broadband data service, for example. A subscriber phone apparatus 100 and corresponding subscriber line 102 is connected to a connector block 110 within the MDF cabinet. The MDF typically comprises columns of connector blocks 110 for the line side that terminates the subscriber lines within the MDF. Furthermore, there are columns of connector blocks 112 on the exchange side for which lines from the exchange that are terminated within the MDF. A cross-connect is generally made by physically installing a jumper wire across the connector blocks that connects the subscriber line to the exchange. To enable telephone service the exchange is connected to the public switched telephone network (PSTN) to route incoming and outgoing calls to and from the subscriber line. The connector blocks used in MDFs are basically similar, however, there are minor variations that are currently in use, the most common being the LSA-Plus connector block manufactured by KRONE Inc., a subsidiary of GenTek Inc. of Hampton, N.H., USA. The KRONE connector blocks are typically able to accommodate up to 2×10 line pairs at a time. Thus there can be 10 subscriber line pairs connected to the connector block for connection to the exchange ports 1-10 respectively. Additional subscriber line pairs are cross-connected to the exchange via further connector blocks to further exchange ports.

The data network 126 can be the Internet, local public or private Intranets, or other types of data networks. The subscriber phone apparatus 100 and computer equipment 101 are connected to a splitter 103 and connected the subscriber line 102. At the MDF the line is connected to connector block 110 however, instead of connecting a jumper wire directly to the exchange side connector block 112, a jumper wire 118 is attached to connector block 120, which feeds into a filter device 122 comprising high and low pass filters for separating the low frequency analog phone signals from the high frequency data signals on the subscriber line. The high frequency signal components are supplied to, or received from, one or more so-called digital subscriber loop access multiplexers (DSLAMs). The DSLAM contain AFE circuitry that includes amplifying circuitry for processing the high frequency signals by digitizing the high frequency signals from the xDSL lines and supplying the resulting digital data signals to a modem 124 for transmission to and from the data network 126.

The low frequency phone signals from the low pass filter are typically routed to a connector block 130 on the line side in order to make a cross-connect back to the connector block 112 for connection to physical exchange port 1 which maintains the original subscriber telephone service and number. It is readily apparent that the installation of xDSL service made in this way is rather labor intensive since the central office must dispatch a technician to manually install the necessary jumper wires for each subscriber installation. Another disadvantage of the installation is that must be added connector blocks on both the subscriber and exchange side must accommodate the rerouted jumper wires thereby increasing costs to the operator. The complete installation involves removing the existing jumper wire and adding at least two new jumper wires. Numerous subscriber installations may require more floor space and eventually make it is necessary to expand the MDF. When a large number of installations are completed, the amalgamation of jumper wires may result in signalling problems from additional capacitance/resistance that can pick up considerable electromagnetic interference from external sources by cross talk from adjacent active pairs. All of these effects can disrupt and reduce the performance of the high-speed data service.

It is not unusual to find, after a thorough check, that as many as 10 percent or more of jumper wire connections turn out to be either undocumented or documented incorrectly due to human error that has accrued over many years. This is also a problem in non-central office sites where jumper cables are used to connect cable pairs in street cabinets and drop points. An accurate accounting of the connection status has proven to be important to operators because an erroneous database can show that a cable pair is connected which may in reality have been disconnected long ago thereby making it difficult to make efficient use of network infrastructure.

As a consequence, telecom operators often carry out periodical verification and documentation of the jumper wire connections in order to update their databases to accurately reflect the current status. This task has traditionally involved a lot of work since technicians are required to the check of lines largely by manual means i.e. the line pairs are checked by hand or with semi-automated techniques using portable electronic gear that are able to scan a limited number of line pairs at a time. Intervention by the technician is typically required to move the scan to the next block of lines and so on in a stepwise manner to complete the scan. However, a significant disadvantage of these and other prior verification techniques is that they require the presence and attentive input of technicians to set up and monitor the equipment for the task. As a consequence, the task is generally regarded as a tedious, costly, and often a time consuming exercise.

In view of the foregoing, it is desirable to provide a fully automatic method and system for scanning, detecting and documenting jumper wires in both central office and non-central office applications within a telecom network.

### SUMMARY OF THE INVENTION

Briefly described and in accordance with embodiments and related features of the invention, there is provided a method and system for automatically scanning, detecting, and documenting existing jumper wires or metallic cross-connects within a central office main distribution frame (MDF) and non-central office sites such as cabinets and drop points. In an embodiment of the invention, the method includes connecting a plurality of modular sender and receiver means to the connector blocks. Scanning signals are transmitted by the sender means between the lines on the subscriber side and the exchange side, which are received by the receiver means in order to accurately determine which subscriber lines are cross-connected to which lines on the exchange side.

In another embodiment of the invention, the scanning system is operable in cooperation with an automated cross-connect system installed within the MDF or e.g. the drop point side. The automated cross-connect system comprises modular cross-connect boards, each comprising switch matrix arrangements that enable cross-connects to be established or removed remotely from the central office. The modular cross-connect boards are inserted into or connected to the connector blocks. A plurality of modular sender and receiver means incorporated into the switch matrix arrangements for which scanning for cross-connects is performed by transmitting scanning signals between the lines on the subscriber side and the exchange side. The transmitted signals are received by the receiver means to accurately detect which subscriber lines are cross-connected to which lines on the exchange side. The scanning procedure establishes an accurate line connection database that enables non-intrusive installation of the automated cross-connect system by preserving previous cross-connects. In a further aspect, the combined operation with the automated cross-connect system enables broken cable lines to be repaired within short order by allowing repair crews to reconnect the splintered ends without regard to order such, whereby afterward, the original line connection sequences are restored by automatically modifying the appropriate cross-connects in the central office or in the drop point side.

### BRIEF DESCRIPTION OF THE DRAWINGS

The invention, together with further objectives and advantages thereof, may best be understood by reference to the following description taken in conjunction with the accompanying drawings in which:

FIG. 1 illustrated the steps required in an exemplary telecom service installation;

FIG. 2 shows an automated cross-connect system installed within an MDF;

FIG. 3 shows a diagrammatic top view of an exemplary automated switch matrix operating in accordance with a first embodiment of the invention;

FIG. 4 shows a perspective view of the sliding contact sledge;

FIG. 5, a side view of a modular cross-connect board inserted into a connector block in accordance with an embodiment of the invention;

FIG. 6 depicts a top view of the connector block with the inserted cross-connect board and switch matrix;

FIG. 7 is a diagrammatic view of the scanning arrangement and switch matrix board operating in accordance with the invention;

FIG. 8 depicts an exemplary modular jumper scanning board operating independently from the automated cross-connect system;

FIGS. 9 and 10 illustrate exemplary three and five stage cross-connect systems;

FIG. 11 is a flow diagram illustrating an exemplary scanning procedure in accordance with the embodiment; and

FIG. 12 shows an exemplary switch matrix access board.

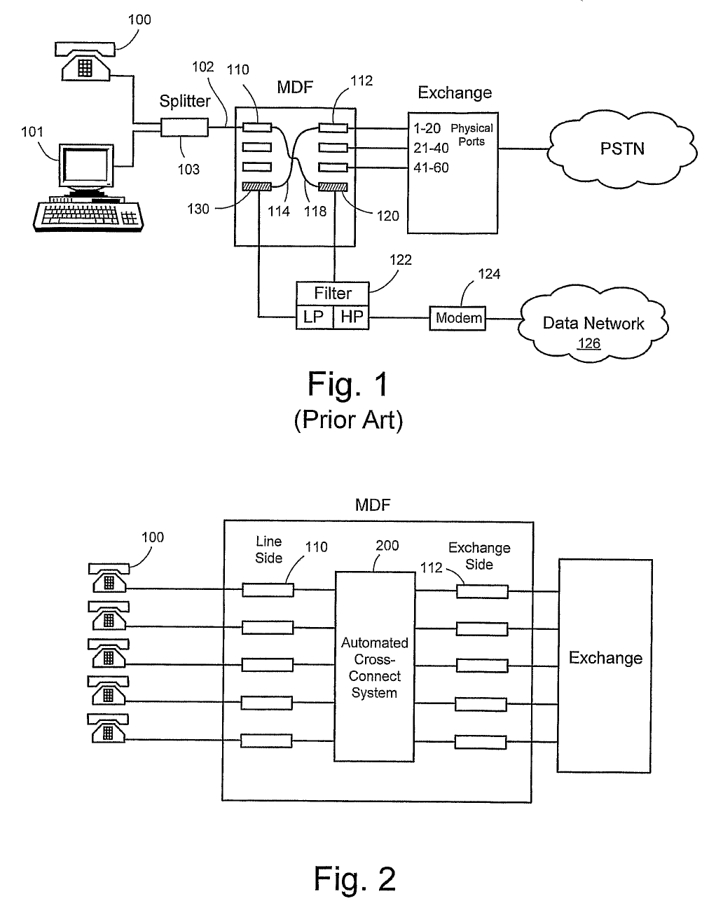

### DETAILED DESCRIPTION OF THE INVENTION

The scanning, verification and accurate documentation of the current jumper wire and line status in telecom networks is important to operators for a number of other reasons besides routine network optimisation and maintenance. By way of example, an important application for line connection data is to assist in the installation of new equipment such as e.g. an automated cross-connect system installed within a central office MDF. The correct prior knowledge of the line status allows for the possibility of non-intrusive installations, i.e. where the current cross-connects of the lines are maintained after installation of the equipment. An effective technique for quickly performing automated scanning and verification of the jumper configuration within an MDF is to connect the verification equipment directly to the connector blocks and scan the entire set of blocks. This type of connection arrangement is already used in some automated cross-connect systems such as the Nexa™ Automated Cross-Connect System manufactured by Network Automation AB of Stockholm, Sweden, described further in Swedish patent application number 0303332-1, which is assigned to the present applicant. Since the installation of the Nexa™ system within the MDF involves connecting the system to the set of connector blocks it becomes sensible to incorporate the scanning and detection function into the system from the start. This would enable the system to obtain the necessary data pre-installation data needed to provide a non-intrusive installation, and has the added benefit that the operator will get accurate line connection data for updating their database with.

FIG. 2 shows an automated cross-connect system 200 such as the Nexa™ system installed within an MDF. The cross-connect system 200 is capable of performing automated cross-connects, for example, subscriber line pair 100 to a port on the exchange, thus enabling so-called ‘any-to-any’ connection of any of the subscriber line pair to any port on the exchange. The system utilizes a plurality of interconnected modular cross-connect boards that are electrically coupled by inserting them into to the connector blocks (110, 112) on both the line and the exchange sides. The connector blocks used in the embodiment described are manufactured by KRONE Inc., which have the capability for allowing the cross-connect boards to be inserted into them. It should be noted that the invention could be used with other types of connector blocks whereby the boards can be connected thereto in ways other than by insertion.

The modular cross-connect boards comprise individual switch matrices that are remotely controllable by the central office. The switch matrix enables cross-connects to be made between the lines in and the lines out of the matrix. In an embodiment of the invention, the scanning and detection system expediently leverages the established connections of the installed automated cross-connect system to connect to the MDF.

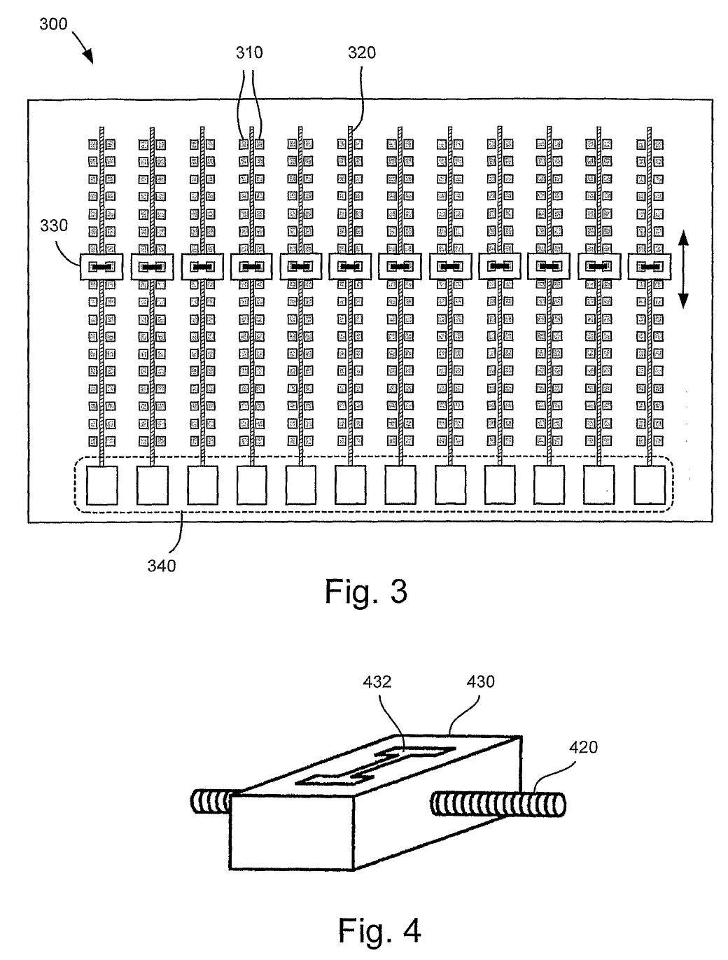

FIG. 3 shows a diagrammatic top view of an exemplary automated switch matrix operating in accordance with a first embodiment of the invention. The switch matrix 300 is configured for cross-connecting a number of input line pairs to a number of output line pairs. The switch matrix board comprises a plurality of electrically conducting contact pads 310 that are formed into a printed circuit board (PCB). The contact pads are arranged into a plurality of longitudinal contact trains by which an electrical connection between them is made when a contact sledge 330 is mechanically slid over the contact pads. The contact pads are connected through the PCB to internal conductor layers that interconnect with other contact pads. It should be noted that although the switch matrix of the embodiment is configured for cross-connecting line pairs, it is possible for the matrix to connect any line in a set of input lines to any line in a set of output input lines a so-called ‘any-to-any’ connectivity. Each of the contact sledges 330 are driven along the contact train by a sledge positioning screw 320, which are rotated by drive means 340 such as stepper motors, for example. The drive means engage with the sledge positioning screws 320 to provide longitudinal movement of the contact sledge 330 along the axis of the positioning screw 320. Rotating the positioning screw 320 in the opposite direction reverses the direction of contact sledge 330 along the contact train.

FIG. 4 shows a perspective view of the sliding contact sledge 430 used in the switch matrix board. The contact sledge is elongated and has contact springs 432 for making contact between the contact points. An additional pairs of contact springs are included on the contact sledge for detecting its position on the matrix and/or for the jumper scanning functionality of the present invention. The contact sledge body contains a threaded hole into which the positioning screw 420 turns to drive the contact sledge to make contact with the appropriate contacts on the switch matrix board. The positioning screw 420 is connected to and driven by a motor e.g. a stepper motor such that reversing its direction moves the sledge in the other direction. The mechanical nature of the switching action of the matrix board provides high operating reliability under a wide range of temperatures.

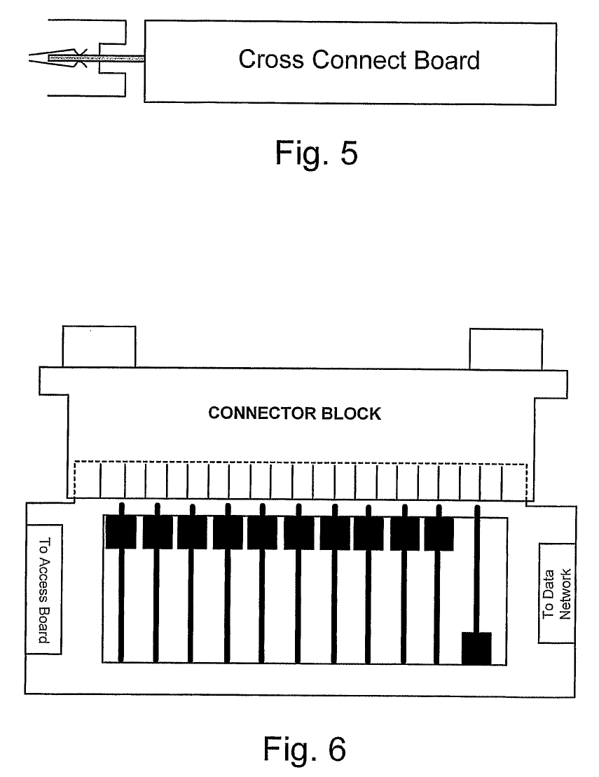

Referring now to FIG. 5, a side view is shown of a modular cross-connect board inserted into an exemplary KRONE LSA-Plus connector block, in accordance with the embodiment of the invention. FIG. 6 depicts a top view of the connector block with the inserted cross-connect board incorporating the switch matrix. In accordance with the embodiment, the connector blocks are electrically coupled to the switch matrix via the cross-connect boards thereby making it possible to connect the sender/receiver units to the line pairs. The sender/receiver units are typically integrated onto a single integrated circuit chip which is a well-known technology and widely available on the market. The sender/receiver unit can select between sending and receiving scanning signals simultaneously on all line pairs, or sending and receiving on each individual line pair. In order to simplify the sending and receiving operation, the cross-connect boards can be restricted to send or receive signals using a spare row and column in the prefabricated switch matrix. This is done to avoid the need to use two additional electromechanical relays on each board, which adds further cost and reduce the reliability of the board over time. In the scanning procedure, the sender/receiver unit typically sends a scanning signal at one end of the line pair and listens for the signal at the receiving end of the sender/receiver unit. By way of example, an exemplary communication protocol such as RS485 can be used and where the sender transmits a board identification address thereby enabling each board to be identified at the receiver of the signal. The scanning signals are transmitted by the sender between the lines on the subscriber side and the exchange side, which are detected by the receiver in order to accurately determine which subscriber line is cross-connected to which line on the exchange side. The results are recorded and logged into a line connection database.

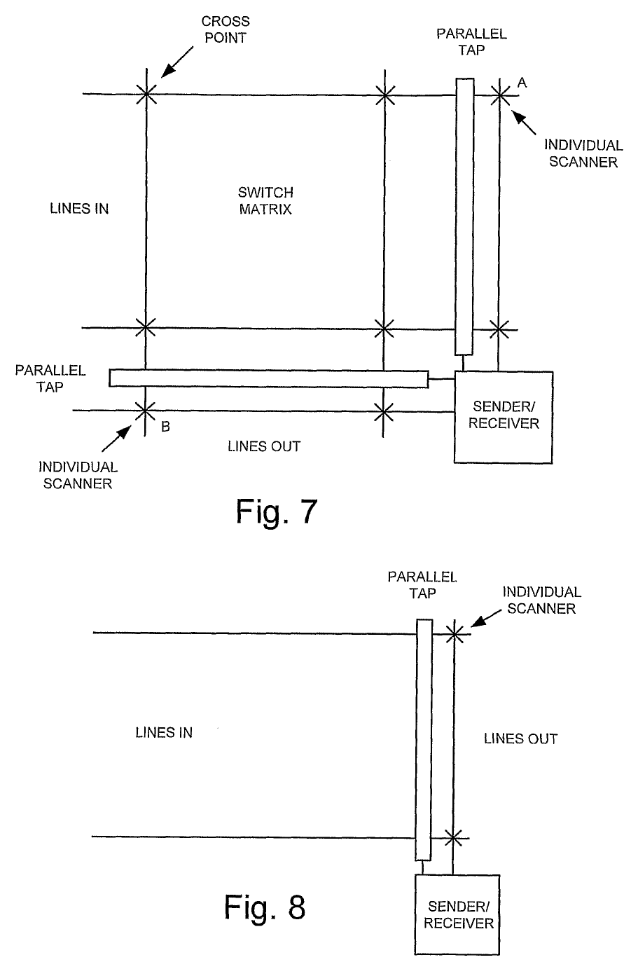

FIG. 7 is a diagrammatic view of the scanning arrangement together with the switch matrix board operating in accordance with the invention. The components used in the scanning board are integrated into the switch matrix board. The switch matrix board contains extra contact pads for contacting corresponding contact springs on the contact sledge 430 to enable scanning signals to be sent and received at the same time. The sender/receiver units, which are addressed by unique identification addresses, are linked to a site controller (not shown) by means of a communication link such as a RS485 bus. The site controller is able to activate senders and receivers as necessary during a scanning procedure where the senders transmit the signal to the cable pairs that can be identified by the receivers. The sender can transmit on one or all line pairs simultaneously via a parallel tap connected to the unit and the input lines. It should be noted that, although it is possible to connect individual sender and receiver units to each of the lines, a single sender/receiver unit is used with the tap, which represents a component for the connection of multiple lines that allows scanning/receiving of individual lines. When a signal the receiver is activated to listen on all output line pairs via a parallel tap. For scanning an individual line the sender transmits the signal on a single input line at point A, which is received on an output line at B. The results are reported to a control unit (not shown) on the board where the information is forwarded to the network management system for analysis by the central office. When the equipment is placed in the different cross connects even the cable pairs between them can be checked.

### Scanning Operation without Cross-Connect System

In another of the invention, the automated jumper verification procedure can be implemented independently of the automated cross-connect system equipment by connecting the sender/receivers directly to the connector blocks. This makes the jumper scanning procedure especially attractive to operators that are only interested in analysing and updating their jumper wiring database that do not have a compatible automated cross-connect system installed in their network.

FIG. 8 depicts an exemplary modular scanning board operating independently from the automated cross-connect system i.e. the scanning boards without the switch matrix. Similarly, the scanning arrangement constituted of modular boards inserted or connected to each of the connector blocks on the line side and exchange side within the MDF or drop point sites. In scanning for cross-connects for a line pair, the sender transmits a scanning signal between the input lines to the output lines to determine which lines are cross-connected. The procedure can be implemented to transmit signals simultaneously for rapid mapping of cross-connects or on an individual line pair depending on the test objectives.

An exemplary scanning procedure operating in conjunction with the switch matrices of the first embodiment is performed as follows. In the first step, all the boards connected on the line side on pair one. Secondly, the switch matrix boards transmit RS485 signals on all output lines pairs on the line side. The signals contain data that identify the sending board and the particular line pair sending the signal such that all the boards are listening to all the input lines to perform the detection. Note that this estimation is relatively independent of installation size since the scanning occurs simultaneously in parallel for each line on all the boards. As the procedure is performed in parallel the completion time depends only on the number of line pairs on each board. It should be noted that the estimated times give are exemplary and that further reductions in scanning time are obtainable by manoeuvring of the boards at a faster rate. The scanning results are stored in the board controller and subsequently sent to the site controller and to the operator. It may to be noticed that there are some breaks of the connections during the scanning. Each line will be opened n×m seconds, where n is the number of lines and m is the time it takes to scan a line pair. As this measurement only will be made once it is probably acceptable and is within specification limits.

Depending on the capacity of the MDF, the configuration of the automated cross connect system typically includes modular switch matrices incorporated in cross-connect boards that are inserted into the line side and exchange side connector blocks that are sometimes referred to as access boards. A center stage comprising additional switch matrix boards are coupled to the access boards is added in larger capacity MDFs. The system is scalable to the growth in subscriber lines serviced the MDF by the installation of additional cross-connection boards to the center stage as necessary to meet the need.

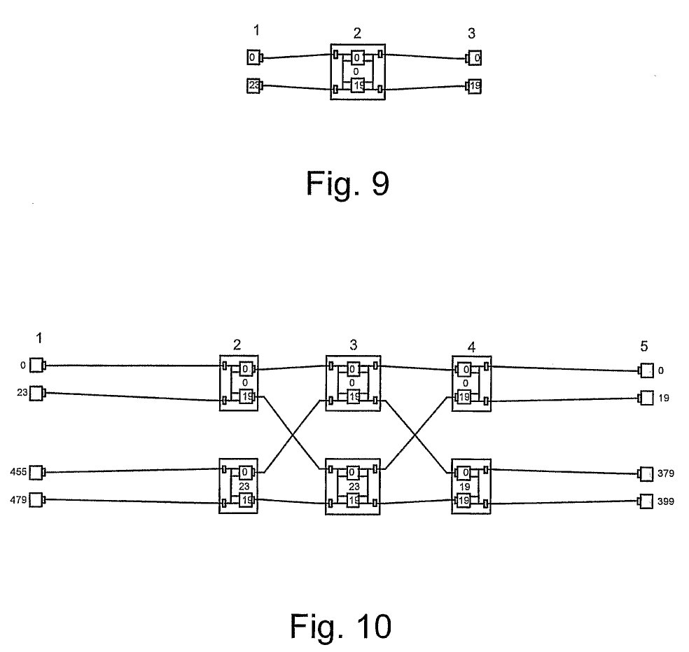

FIG. 9 shows an exemplary three-stage cross-connect system having access boards on the line side and exchange side at positions 1 and 3 respectively and center stage at position 2. The solid lines connecting the access boards to the center stage represent 20 line pair cables that are equal on both ends. In this example, there are 24 ports oriented on line side comprising ports 0 to 23 whereby there 20 ports on the exchange side i.e. ports 0 to 19 since there are typically more line pairs on the access side. This is typically because within the CO the number of subscribers assigned to the exchange is not known from the start. Also, there are usually a number of freed access lines from subscriber service removals. The center stage comprises 0 to 19 ports that are interconnected to both the line and exchange side access boards. In the figure the squares represent 24×20 line pairs on the switch matrix boards. The exemplary three stage example handles a capacity of 480/400 i.e. lines in/lines out. It should be noted that the specific capacities of the switch matrix modules are exemplary whereby other dimensions can be used with the invention.

FIG. 10 shows an exemplary five-stage cross-connect system having access boards on the line side and exchange side at positions 1 and 5 respectively with center stage comprising center stage boards at positions 2-4. In this example, the five stages handle approximately 11520/8000 line pairs. When expanded to seven stages the system can handle up to 276480/160000 line pairs or even more with the addition of further stages.

### Scanning for Internal System Cables

Once the automated cross-connect system such as the Nexa™ system is installed it is necessary to scan the internal system cables to verify that the installation was achieved correctly and/or to build up the associated databases for the installation. In principle, little documentation is needed for the installation if the Nexa™ scanning mechanism is used to build up the internal databases. What needs to be determined is where the each of the different modular switch boards that belong to a specific switching stage is located i.e. either in stage 2, 3, or 4 in the case of a five-stage system or in stage 2,3,4,5, or 6 in a seven-stage system. Since all the modular boards are equipped with both senders and receivers it is possible to scan all stages in parallel.

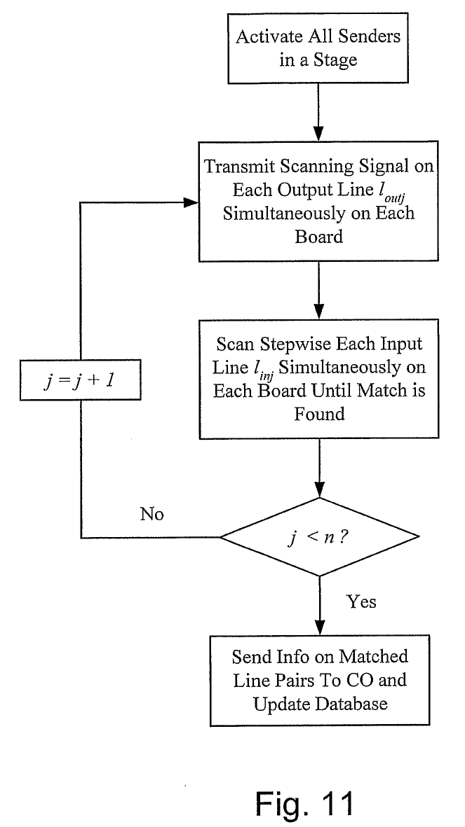

FIG. 11 is a flow diagram illustrating an exemplary scanning procedure in accordance with the embodiment. In a first step, all senders in one stage are activated to transmit a scanning signal on each output line 1 or lₒᵤₜⱼ on all boards simultaneously, where j=1. In a following step, the signals are received on the input line side where each input line lᵢₙⱼ on each board is scanned for the received signal in a stepwise manner. This is accomplished by moving the contact sledges of the switch matrix systematically while listening on all input lines in order to detect signal which indicates the specific board in order to match the line pair to the signal. In the next step, a scanning signal is transmitted simultaneously on each of the boards for the next output line where a corresponding scanning on the input line side is conducted to determine the matched line pair. The scanning process is continued until all output lines n are completed i.e. where j is less than or equal to n. The information is indicative of cross-connected line pairs and is sent to the site controller, which in turn is used to update the CO databases and to route connections through the Nexa™ system. This procedure will continue with transmitting simultaneously on all output lines two on each of the boards with a correspondingly new step-by-step scan of input lines. The scanning procedure continues until all output lines have been activated and input lines scanned. At this stage, no disturbances or signal loop back issues are present since the system at this point has not been connected to the CO equipment. Furthermore, disturbance issues are also avoided during operation because the internal scanning uses only the spare contact positions on the switch matrix that are not associated with the primary contact positions used for making the line cross-connects.

### Scanning for Existing Jumper Connections to Verify Existing Databases

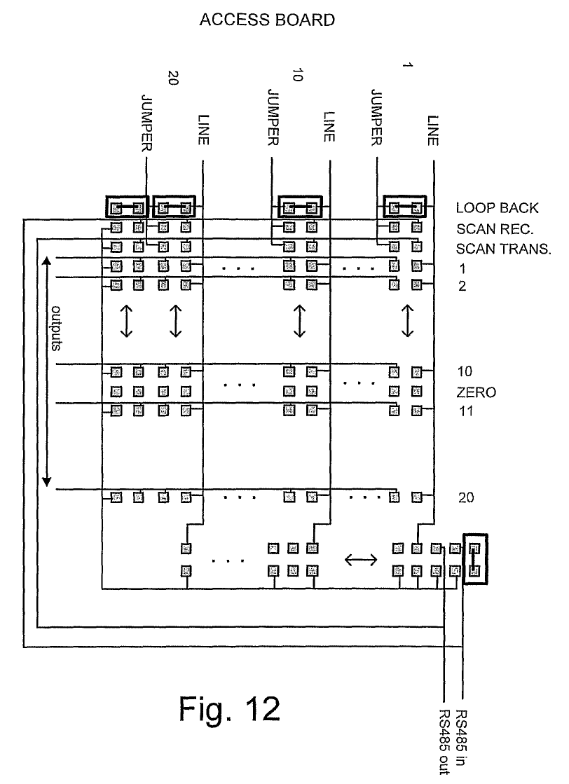

Referring now to FIG. 12, there is shown an exemplary access board for use on the line or exchange side. The scanning procedure can be performed to verify an existing database and perform corrections thereto to enable the automated cross-connect system to set up equivalent operating conditions as prior to installation before entering service. The verification scan uses the two spare position contact pads oriented on the line and exchange side access boards i.e. oriented in the line of direction of the contact sledge movements the same as for the loop back function i.e. the sledges are associated with the line numbering and the exchange pair numbering.

There are three positions that are oriented in this direction i.e. the loop back position, and the scanning transmit and receive positions for sending and receiving the signals via the communication protocol such as RS485. In each position the communication protocol transmits a board identification address to identify the specific board. In order to avoid signal collisions as much as possible between the senders, the signals are sent first from all boards on the exchange side. Here the signals are sent simultaneously from all boards on each output line 1 respectively and scan on the other side i.e. the respective line side on all input lines for each board. As the scan is able to detect the connected line pair the collected information is sent to the site controller and compared with the existing databases of the operators O&M system. The information will also be used to initialize the Nexa™ system before beginning initial operations. It should be noted that for this function the Nexa™ system switch matrix is not necessarily required but only use of the three contact positions associated with the jumper side of the MDF block. It should also be noted that for each scan there would be a short break or open circuit position on each of the existing connections. One break position is related to the transmission of signals further break positions for each of the input lines e.g. and additional 20 break positions for a 20×20 matrix.

### Scanning for Cable Repair within and Outside of Central Office

It not unusual that telephone trunk lines are broken from time to time by frequent construction activity in urban environments. A major trunk line can contain thousands or tens of thousands of individual lines, that when broken, disrupts service, which is a significant reason why it often takes so long to the restore service. Often repairs are performed using manual verification means, which is labor intensive, time consuming and expensive. The use of automated scanning on both ends of the broken lines would enable one to determine rapidly which of the thousands of broken line ends on both sides need to be reconnected.

The technique of the invention can be used for checking the cable pairs between the central office and the street cabinets or drop points. As the standard RS 485 communication link typically only reaches about 1300 meters, a separate transmitter could be used which will be connected through the Nexa™ cross-connect system to the appropriate line. The RS485 transmitter can use a much higher voltage than that the normally used 5V line. Thus the receivers must be protected from the higher voltages, which is not a problem since surge protectors are already used to protect them from exposure from spikes caused by lightning strikes and the like.

Repairs to broken cable lines can be quickly repaired using the Nexa™ system by transmitting signals through a desired cable pair on both sides of the cable break. The cross-connect system may be installed temporarily in at least the street cabinet and/or drop point closest to the break location. In this case the communication with Nexa™ system is preferably performed by wireless communication link. To implement the procedure more efficiently, the process is based off the initial start data that indicates which specific subscriber lines should be connected to which exchange inputs, whereby a simple signal can be used to jump to the next cable pair, which takes place relatively quickly e.g. approximately within a second. In one repair technique, when the Nexa™ or similar system is installed in the MDF and the street cabinets or drop points, the break point in the lines can be detected by sending a tone at one end and listening at break point to enable rapid verification of the correct line for repairs. In a second repair technique, using the Nexa™ or similar system installed at both ends of the MDF and street cabinet/drop point, where the cable break point is located in between, the lines can be connected in any order without regard to the original sequence of the line pairs, which significantly shortens the repair time. Once the all the connections are made, the correct line can be ‘matched’ with the correct subscriber using the scanning technique of the present invention and the switching facilities within Nexa™ cross-connect system. A major advantage is that a single person can make the necessary repairs to restore service quickly and efficiently.

### Connections Between Low and High Voltage Boards

The implementation of the scanning functions of the invention require there to be connections between the low voltage and high voltage boards, since in the exemplary embodiment, the controller is located on the low voltage board. Great care must be taken when making the connections. Normally the RS485 lines are disconnected from the input lines, however the receivers must still be protected. FIGS. 11 and 13 illustrate an arrangements in the access and center stage boards that allow the RS485 communication lines to be disconnected while connecting the transmitters and receivers while still maintaining the connection between the spare vertical and horizontal rows and columns in the switch matrix boards.

For the access boards, a specific zero position (no connection) is used but for center stage board zero positions between the contact pads are used since no lines are connected to the links in that position. The zero position on the access boards are set in between the contact pads to reduce the set up time by up to half the normal time. The over voltage protectors (OVPs) for the sender/receiver are positioned on the low voltage boards in order to avoid soldering on the high voltage boards. Thus requiring the grounding to be done through the high voltage board by adding two extra signals for that.

The foregoing description of the preferred embodiments of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. The embodiments were chosen to explain the principles of the invention and its practical application, thereby enabling those skilled in the art to utilize the invention for the particular use contemplated. Still, it is to be appreciated that the scanning functionality of the invention can be operated independently from or in conjunction with the automated cross-connect system within the MDF, street cabinet or drop point site. It is therefore the intention that the following claims not be given a restrictive interpretation but should be viewed to encompass variations and modifications that are derived from the inventive subject matter disclosed.

1. A system for scanning to detect jumper wires or metallic cross-connects within a central office main distribution frame (MDF) that comprises a plurality of connectors blocks housed therein for terminating a plurality of input lines from the subscribers and output lines to a telephone exchange, wherein the subscriber lines are cross-connected to the exchange via the metallic cross-connects, and wherein a plurality of modular sender and receiver means are connected to the connector blocks such that scanning signals transmitted by the sender means are received by the receiver means to automatically determine which of the input lines are cross-connected to which of the output lines.

2. The scanning system according to claim 1, wherein the scanning system is operable in cooperation with an automated cross-connect system 200 for remotely managing cross-connects between the subscriber lines and the exchange, said automated cross-connect system comprise a plurality of modular cross-connect boards having switch matrix arrangements that are connected to the plurality of connector blocks within the MDF, wherein the automated cross-connect system 200 is able to remotely establish and remove cross-connects between the subscriber lines and the exchange.

3. The scanning system according to claim 2, wherein switch matrix arrangement includes a plurality of electrically conducting main contact pads disposed thereon and arranged in a plurality of contact trains, and wherein said contact means includes a set of main contact springs that are slidably engageable with said main contact pads for cross-connecting the lines, and wherein the switch matrix arrangement further comprises includes a plurality of contact pads for a loop back function for preserving pre-existing jumper wire connections and a plurality of contact pads for scanning by communicating signals to and from said sender and receiver means.

4. The scanning system according to claim 2, wherein a cross-connect database is created and/or updated by an automatic scan of the input and output lines on the modular cross-connect boards.

5. The scanning system according to claim 2, wherein each board comprises means for scanning individual lines that receive the scanning signals.

6. The scanning system according to claim 1, wherein the system is installed in non-central office sites such as street cabinets and drop points, which are controlled and in communication with the central office.

7. The scanning system according to claim 2, wherein a site controller is linked to the central office and to the cross-connection boards via a communication link that also provides power to the cross-connect boards to operate the cross-connects.

8. The scanning system according to claim 2, wherein a center stage is included within the MDF that comprises a plurality of cross-connect boards having switch matrix arrangements that are interconnected to the access cross-connect boards that connected to the connector blocks.

9. A method of scanning to detect metallic cross-connects within a central office main distribution frame (MDF) that comprises a plurality of connectors blocks housed therein for terminating a plurality of lines from the subscribers and lines to a telephone exchange, wherein the subscriber lines are cross-connected to the exchange via the metallic cross-connects, the method comprising the steps of:
connecting a plurality of modular sender means boards and receiver means boards to the connector blocks;
transmitting a scanning signal on a line in a first set of lines;
scanning to detect the line in a second set of lines that has received the transmitted signal;
repeating the scanning procedure until all lines in the first set of lines have been completed;
and determining the lines in the first set of lines and the lines in the second set of lines that are cross-connected together.

10. The method according to claim 9, wherein the scanning system operates in co-operation with an automated cross-connect system 200 for remotely managing cross-connects between the subscriber lines and the exchange, the automated cross-connect system comprises a plurality of modular cross-connect access boards having switch matrix arrangements that are connected to the plurality of connector blocks within the MDF.

11. The method according to claim 9, wherein the switch matrix arrangements include a plurality of electrically conducting main contact pads disposed thereon and arranged in a plurality of contact trains, and wherein said contact means includes a set of main contact springs that are slidably engageable with said main contact pads for cross-connecting the lines, and wherein the switch matrix arrangement further comprises includes a plurality of contact pads for a loop back function used in preserving pre-existing jumper wire connections after installation, and a plurality of contact pads for sending and receiving signals from the sender and receiver means.

12. The method according to claim 9, wherein a database is created and/or updated by the results of the scanning procedure.

13. The method according to claim 10, wherein the scanning procedure is performed to verify and correct a pre-connection database that enables the automated cross-connect system to provide the pre-installation cross-connect conditions to provide a non-intrusive installation by preserving previous cross-connects.

14. The method according to claim 9, wherein the scanning signal including the board ID is transmitted simultaneously by the sending means on a line in the first set of lines corresponding to each of the modular boards, and the lines in the second set of lines are scanned to determine which of the lines received the corresponding signal for each of the modular boards.

15. The method according to claim 9, wherein the system is installed in non-central office sites such as street cabinets and drop points, which are controlled by the central office.

16. The method according to claim 9, wherein a site controller is linked to the cross-connection boards via a communication link that also provides power to the cross-connect boards to operate the cross-connects.

17. The method according to claim 9, wherein cable pairs between the central office and a drop point site are scanned to verify and accurately document the line connection status.

18. The method according to claim 10, wherein broken cable lines occurring between the central office and a drop point site are repaired by connecting the broken cable ends together, without regard to previous connection sequence, such that the original connection sequences for the lines are restored by automatically modifying the cross-connects in the central office and/or in the drop point site.

19. The method according to claim 9, wherein the plurality of modular sender means and receiver means boards connected to said connector blocks are connected to a controller enabling automated scanning at the MDF or from a central office remote location.
